(19) United States
(12) Patent Application Publication
(10) Pub. No.: US 2007/0024653 A1
(43) Pub. Date: Feb. 1, 2007

(54) Printing system and method using file transfer protocol

(75) Inventor: Hong-Seock Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/369,880

(22) Filed: Mar. 8, 2006

(30) Foreign Application Priority Data
Jul. 27, 2005 (KR) 2005-0068239

(51) Int. Cl. B41J 29/38

(52) U.S. Cl. 347/14

(57) ABSTRACT

A printing system and method are provided for using File Transfer Protocol (FTP) in conjunction with a user terminal and an image forming apparatus. The printing system using FTP comprises a user terminal for transmitting print options and print data using FTP, and an image forming apparatus for receiving print options and print data, and executing a printing operation on the print data by applying the received print options. The print options are defined in the form of FTP extension commands, and the user terminal transmits extension commands through a port transmitting standard FTP commands. Since only the FTP protocol is used, user terminal and image forming apparatus resources, as well as network resources, can be conserved.

### PRIORITY

This application claims benefit under 35 U.S.C. § 119(a) of Korean Patent Application No. 2005-68239, filed Jul. 27, 2005, in the Korean Intellectual Property Office, the entire content of which is hereby incorporated by reference.

### BACKGROUND OF THE INVENTION

1. Field of the Invention

The present invention relates generally to a printing system and method using File Transfer Protocol (FTP). More particularly, the present invention relates to a printing system and method using FTP, and a user terminal and an image forming apparatus used for the same, in a manner that prevents waste of user terminal resources and resources of the image forming apparatus and network.

2. Description of the Related Art

FIG. 1 is a diagram for explaining a conventional network printing process using FTP. FTP network printing refers to work including file (document) transmission to an image forming apparatus using FTP and printing/storing the document in the image forming apparatus. FTP, or file transfer protocol, is a protocol used for exchanging files between devices such as hosts over the Internet.

According to conventional FTP network printing, when a user wants to transmit print data from his terminal 10 to an image forming apparatus 20 for printing, the print data is transmitted using FTP 40 but via a different protocol for setting the print option. Typically, the print option is obtained and set by using Service Locator Protocol (SLP) 30.

The user terminal 10 has an FTP module, which is a program for exchanging files using FTP 40, and transmits print data to the image forming apparatus 20 using this module. The image forming apparatus 20 also has an FTP module through which it receives and stores print data from the user terminal 10. The image forming apparatus 20 has a port for transmitting/receiving control information required for exchanging data, and a port for transmitting/receiving print data.

The user terminal 10 also has an SLP module, which is a program for using the SLP 30, and transmits the print option to the image forming apparatus 20 using the module. The image forming apparatus 20 also has an SLP module, which is a program for using the SLP 30. Using the SLP module, the image forming apparatus 20 suggests available print options and executes a necessary operation on print data processed by the user terminal 10. The image forming apparatus 20 has ports available to transmit/receive data configured for SLP.

As such, conventional FTP network printing can only be executed if both user terminal 10 and image forming apparatus 20 are equipped with an FTP module and an SLP module. Such a configuration requires increased program size and represents an inefficient use of network resources because different protocols and different image forming apparatus ports are required.

### SUMMARY OF THE INVENTION

Accordingly, it is an object of the present invention to provide a printing system and method using only FTP. Exemplary embodiments of the present invention employ a user terminal and an image forming apparatus used for the same. In so doing, the present invention reduces user terminal resource waste and image forming apparatus and network resources.

To achieve the above objects and advantages, there is provided a printing system using FTP (File Transfer Protocol) according to an exemplary aspect of the present invention comprising a user terminal for transmitting print options and print data using FTP, and an image forming apparatus for receiving the print options and print data, and executing a printing operation on the print data by applying the received print options.

In an exemplary implementation, the print options may be defined in the form of FTP extension commands.

In another exemplary implementation, the user terminal may transmit the extension commands through a port transmitting standard FTP commands.

If the image forming apparatus does not support the extension command, the image forming apparatus may ignore the extension commands and execute the printing operation according to the standard FTP command.

Another aspect of the present invention provides a printing method using FTP comprising a user terminal, transmitting print options and print data using FTP, receiving the print options and print data in an image forming apparatus and executing a printing operation on the print data by applying the received print options.

In an exemplary implementation, the print options may be defined in the form of FTP extension commands.

In another exemplary implementation, the extension commands may be transmitted through a port transmitting standard FTP commands.

The printing method further comprises, if the image forming apparatus does not support the extension command, the image forming apparatus may ignore the extension commands and execute the printing operation according to the standard FTP command.

Still another aspect of the present invention provides a user terminal using FTP comprising a user interface unit for receiving print options and print data, a transmission unit for transmitting the print options and print data being inputted to an image forming apparatus, and a control unit for controlling the transmission unit to transmit the print options and print data using FTP.

In an exemplary implementation, the print options may be defined in the form of FTP extension commands.

In an exemplary embodiment of the present invention, the transmission unit comprises a first port for transmitting the extension commands to the image forming apparatus, and a second port for transmitting the print data to the image forming apparatus.

In an exemplary implementation, the first port comprises the same port used for transmitting the standard FTP commands.

Yet another aspect of the present invention provides an image forming apparatus using FTP comprising a receiving unit for receiving print options and print data, a print engine for printing the received print data, and a control unit for directing the receiving unit to receive the print options and the print data using FTP and for directing the print engine to execute the printing operation on the print data by applying the received print options.

In an exemplary implementation, the print options may be defined in the form of FTP extension commands.

In an exemplary embodiment of the present invention, if the extension commands are not supported, the control unit may ignore the extension commands and perform necessary control operations according to standard FTP commands.

In an exemplary implementation, the receiving unit comprises a first port for receiving the extension commands, and a second port for receiving the print data.

In an exemplary implementation, the first port comprises the same port used for receiving the standard FTP commands.

### BRIEF DESCRIPTION OF THE DRAWINGS

The above aspects and features of the present invention will be more apparent by describing certain exemplary embodiments of the present invention with reference to the accompanying drawings, in which:

FIG. 1 is a diagram for explaining a conventional FTP network printing;

FIG. 2 is a functional block diagram showing the configuration of a user terminal using FTP, according to an exemplary embodiment of the present invention;

FIG. 3 is a functional block diagram showing the configuration of an image forming apparatus using FTP, according to an exemplary embodiment of the present invention;

FIG. 4 is a diagram for explaining the transmission/receiving of print data and print options using FTP, according to an exemplary embodiment of the present invention;

FIG. 5 is a flow chart explaining a printing method using FTP according to an exemplary embodiment of the present invention; and

FIG. 6 is a flow chart explaining a printing method using FTP according to another exemplary embodiment of the present invention.

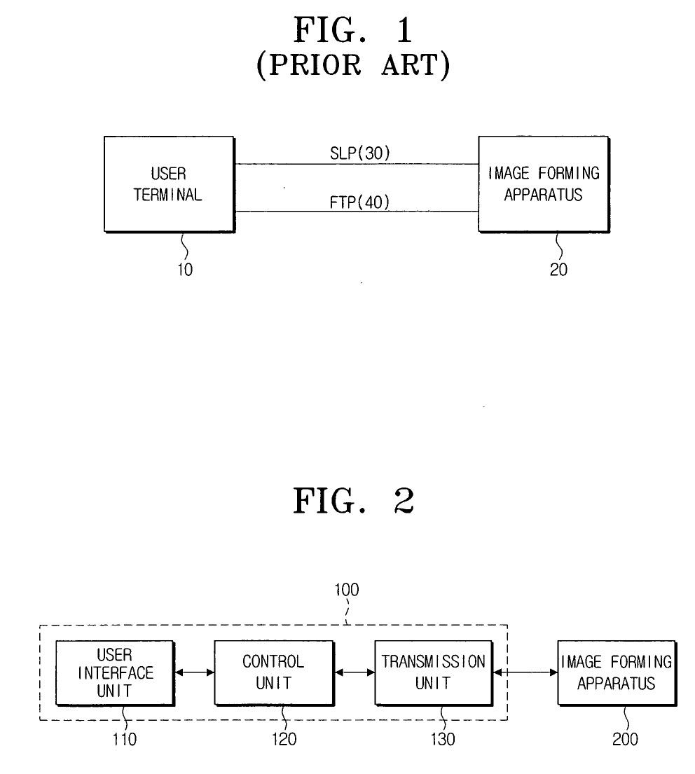

Throughout the drawings, like reference numbers should be understood to refer to like elements, features, and structures.

### DETAILED DESCRIPTION OF EXEMPLARY EMBODIMENTS

The matters exemplified in this description are provided to assist in a comprehensive understanding of various exemplary embodiments of the present invention disclosed with reference to the accompanying figures. Accordingly, those of ordinary skill in the art will recognize that various changes and modifications of the exemplary embodiments described herein can be made without departing from the scope and spirit of the claimed invention. Descriptions of well-known functions and constructions are omitted for clarity and conciseness.

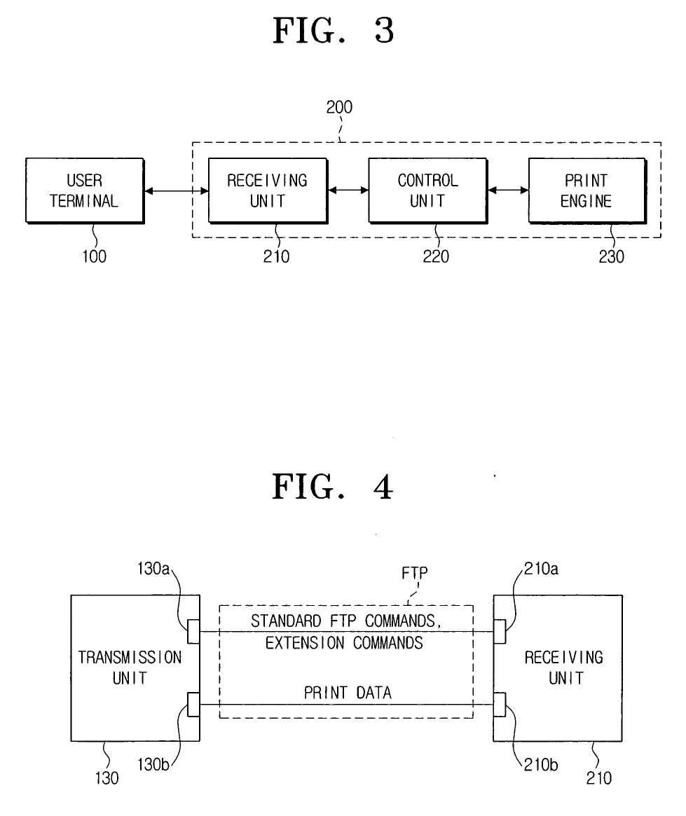

FIG. 4 is a diagram for explaining the transmission/receiving of print data and print options using file transfer protocol (FTP) in accordance with one exemplary embodiment of the present invention. In particular, FIG. 4 depicts FTP as used for the exchange of print data and print options between a transmission unit 130 of a user terminal 100 and a receiving unit 210 of an image forming apparatus 200.

File transmission and receiving according to FTP is executed through control connection and data connection. The control connection is a communication path between an FTP client and an FTP server for exchanging command and replay. In an exemplary embodiment of the present invention, the user terminal 100 corresponds to the FTP client, and the image forming apparatus 200 corresponds to the FTP server storing files. For example, according to a Request for Comments (RFC), when the FTP client 100 transmits a connection request command through TCP port 21 130a, the FTP server 200 receives the command and replies through port 21 210a. Referring to Table 1, the variety of commands the FTP client transmits to the FTP server are defined in advance according to protocols used. These pre-defined, protocol-based commands are called ‘standard FTP commands.’

In an exemplary embodiment of the present invention, in addition to standard FTP commands, print options for print data are also predefined between the FTP client and the FTP server. For convenience, these pre-defined commands for print options between the FTP client and the FTP server are called ‘FTP extension commands’. For example, as listed in Table 1 below, commands related to file print, number of pages per print paper, double-sided print, among others, can be pre-defined as FTP extension commands. Therefore, without using conventional SLP, the commands for print options can be transmitted using only FTP. If the FTP extension commands are defined according to the RFC, port 21 (130a and 210a) may be used for transmitting and receiving standard FTP commands. This is desirable from the perspective of saving port resources.

TABLE 1

| | Commands | Description |
|---|---|---|
| Standard | ABOR | Abort data connection process |
| FTP | LIST <name> | List information if name is a file or list |
| commands | | files if name is a directory. |
| | PASS <password> | Password for system log-in |
| | QUIT | Log off from the FTP server |
| | RETR <filename> | Retrieve (copy) file from server |
| | STOR <filename> | Store (copy) file to server |
| | USER | User name for system log-in |
| | <username> | |
| FTP | PRN <filename> | Print file |
| | PAGE 2 | Print 2 pages per print paper |
| Extension | DUPL | Double-sided print |
| commands | | |

Data connection is a communication path for exchanging a portion of or entire files, or several files between the FTP client 100 and FTP server 200. For instance, suppose that the FTP client 100 transmits a file save request command to the FTP sever 200 through the TCP port 21 130a, and the FTP server 200 replies through port 21 210a, accepting the request. The FTP client 100 then transmits files of interest through the port 22 130b, and the FTP server receives the files through the port 22 210b. In this manner, print data or print-ready materials can be transmitted and received through port 22 130b and 210b, in a manner similar to conventional practice.

FIG. 2 is a functional block diagram showing the configuration of a user terminal using FTP according to an exemplary embodiment of the present invention. As shown in the drawing, the user terminal 100 includes a user interface unit 110, a transmission unit 130, and a control unit 120.

The user interface unit 110 receives print options and print data. Print options specify the type or pattern of print data the user wants the print data to follow, such as whether to print, the print range, the number of sheets to print, the number of pages printed per print paper, among others. To achieve FTP network printing using only FTP, it is desirable to define all print options in terms of the FTP extension commands. For example, extension commands like the commands listed in Table 1 should be pre-defined between the user terminal 100 and the image forming apparatus 200.

The user interface 110 may receive extension commands similar to the commands shown in Table 1 in at least one of a text format directly from the user, such as, for example, “PRN aaa.txt” or “PAGE 4”, or in a Graphic User Interface (GUI) format for setting desired print options. The transmission unit 130 transmits print options and print data being inputted to the image forming apparatus 200. To this end, as shown in FIG. 4, the transmission unit 130 includes a first port 130a for transmitting extension commands to the image forming apparatus 200, and a second port 130b for transmitting print data to the image forming apparatus 200. If FTP extension commands are defined according to the RFC, port 21, which is originally used for transmitting standard FTP commands, may be used as the first port 130a for transmitting the FTP extension commands. In this manner, port resources can be conserved.

The control unit 120 directs the transmission unit 130 to transmit print options and print data provided through the user interface unit 110 by using FTP. When FTP extension commands are provided for the print option in text format directly from the user interface unit 110, the transmission unit 130 transmits the extension command as is, under the direction of the control unit 120. Meanwhile, if the print option is provided in GUI format, the print option is converted into an appropriate extension command and transmitted by the transmission unit 130.

FIG. 3 is a functional block diagram showing the configuration of an image forming apparatus using FTP according to an exemplary embodiment of the present invention. As shown in FIG. 3, the image forming apparatus 200 comprises a receiving unit 210, a print engine 230, and a control unit 220.

The receiving unit 210 receives print options and print data that the user terminal 100 transmitted. The print options are preferably FTP extension commands that are pre-defined between the user terminal 100 and the image forming apparatus 200. Referring to FIG. 4, the receiving unit 210 includes a first port 210a for receiving extension commands from the user terminal 100, and a second port 210b for receiving print data. If the FTP extension commands are defined according to the RFC, port 21, which is originally used for receiving standard FTP commands, may be used as the first port 210a for receiving FTP extension commands. In this manner, port resources can be conserved.

The print engine 230 prints the print data being received. When using a laser printer, a laser scanning unit (LSU) is driven to execute the printing operation.

The control unit 220 directs the receiving unit 210 to receive print options and print data using FTP. The print engine 230 then prints the print data based on the received print options, under the direction of the control unit 220. This procedure is possible if the image forming apparatus 200 supports the FTP extension commands defining print options. Thus, if the image forming apparatus 200 does not support the FTP extension commands, the print engine 230 executes the printing operation on the print data according to standard FTP commands, and the extension commands are ignored. In this case, the image forming apparatus functions as a typical FTP server for the FTP client. Hence, although there may be no extension command, the print data can still be printed according to standard FTP commands.

Since a printing system provided with the user terminal 100 and the image forming apparatus 200 described above can execute the printing operation using only FTP, additional protocol, or port and program for executing the additional protocol, are not required.

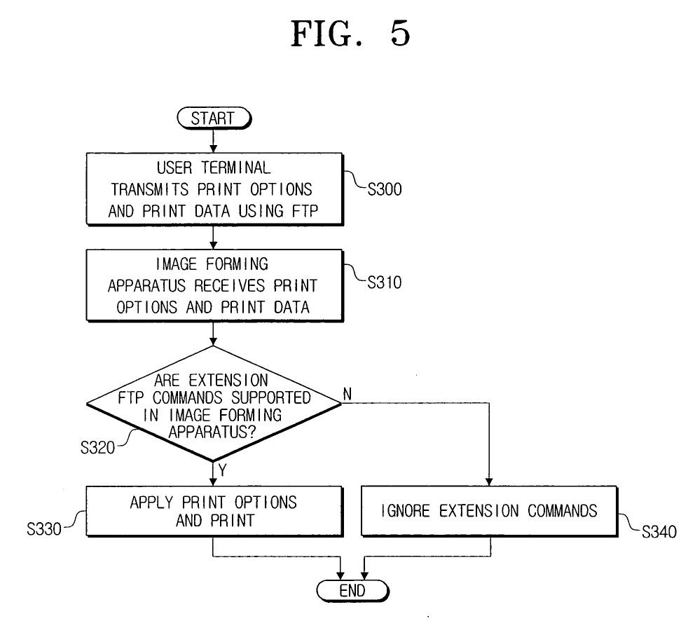

FIG. 5 is a flow chart for explaining a printing method using FTP according to an exemplary embodiment of the present invention. For the following description, FIGS. 2, 3 and 5 will be referenced.

The transmission unit 130 of the user terminal 100 transmits print options and print data to the image forming apparatus, step S300. To this end, the user interface 110 receives the print options and print data. The print options specify the type or pattern the user wants the print data to follow, such as, for example, whether to print, print range, number of print sheets, and number of pages printed per print paper. To achieve FTP network printing using only FTP, it is desirable to predefine all print options in terms of FTP extension commands. For example, extension commands like the commands listed in Table 1 may be pre-defined between the user terminal 100 and the image forming apparatus 200. Thus, not only print data but print options can be transmitted and received using FTP. Therefore, it is no longer necessary to use both an FTP module and SLP module separately.

Referring to FIG. 4, the transmission unit 130 comprises a first port 130a for transmitting extension commands to the image forming apparatus 200, and a second port 130b for transmitting print data to the image forming apparatus 200. If the FTP extension commands are defined according to the RFC, port 21, which is originally used for transmitting standard FTP commands, may be used as the first port 130a for transmitting the FTP extension commands. Thus, port resources can be conserved.

The control unit 120 directs the transmission unit 130 to transmit the print options and print data provided through the user interface unit 110 by using FTP. When the extension command for a print option is received in text format directly from the user interface unit 110, the transmission unit 130 transmits the extension command as is, under the direction of the control unit 120. Meanwhile, if the print option is provided in GUI format, the print option is converted into an appropriate extension command and transmitted by the transmission unit 130.

The receiving unit 210 of the image forming apparatus 200 receives print options and print data that the user terminal 100 transmitted, step S310. Referring to FIG. 4, the receiving unit 210 comprises a first port 210a for receiving extension commands from the user terminal 100, and a second port 210b for receiving print data. If the FTP extension commands are defined according to the RFC, port 21, which is originally used for receiving standard FTP commands, may be used as the first port 210a for receiving FTP extension commands.

The control unit 220 directs the receiving unit 210 to receive print options and print data using FTP, and directs the print engine 230 to print the print data by applying the received print options. Therefore, the control unit 220 determines whether the image forming apparatus 200 supports the FTP extension command defining print options, step S320. When the image forming apparatus 200 supports FTP extension commands in step S320, the control unit 220 directs the print engine 230 to execute the print data by applying the print options. In response, the print engine 230 executes the printing operation on the received print data, step S330.

However, if the image forming apparatus 200 does not support the extension FTP command in step S320, the control unit 220 ignores the extension command, step S340. That is, the print engine 230 is directed to execute the printing operation on the print data according to standard FTP commands. In this case, the image forming apparatus acts as a typical FTP server for the FTP client.

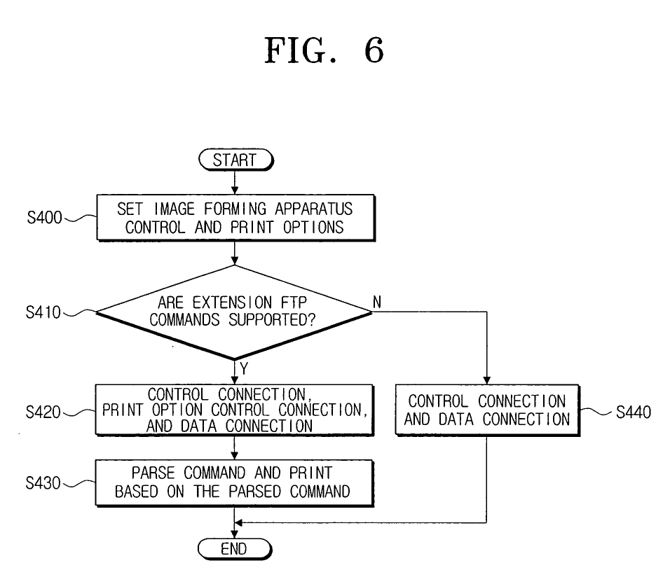

FIG. 6 is a flow chart for explaining a printing method using FTP according to another exemplary embodiment of the present invention.

The user interface 110 receives a print option, step S400, as is done to control a conventional image forming apparatus. File transmission and receipt according to FTP is executed through control and data connections. The image forming apparatus control set-up indicates the set-up process for control connection. This is usually achieved through standard FTP commands.

Preferably, in an exemplary embodiment of the present invention, the print option is in the form of FTP extension commands that are pre-defined between the user terminal 100 and the image forming apparatus 200. For example, the extension commands listed in Table 1 may be pre-defined between the user terminal 100 and the image forming apparatus 200, in accordance with the RFC.

The control unit 120 determines whether the image forming apparatus supports FTP extension commands defining the print option between the user terminal 100 and the image forming apparatus 200, step S410. The control unit 120 directs the transmission unit 130 to transmit print options and print data, which are provided through the user interface 110, by using FTP. Commands for the image forming apparatus control and print options can be directly provided to the user interface unit 110 in at least one of a text format or GUI format. For example, when the FTP extension command is included in the FTP client module installed in the user terminal 100, the control unit 120 determines whether the command being provided in text format through the user interface unit 110 is one of the FTP extension commands that are supported and pre-defined between the user terminal 100 and the image forming apparatus 200. Meanwhile, if the image forming apparatus control and print options are provided in GUI format, they are converted into appropriate extension commands and transmitted by the transmission unit 130, under the directions of the control unit 120.

When the image forming apparatus supports an FTP extension command of interest, step S410, the transmission unit 130 executes at least one of control connection, print option control connection, and data connection, step S420. The control connection is executed by transmitting standard FTP commands, and the print option is executed by transmitting FTP extension commands. The data connection indicates the transmission process of data to be printed. For instance, when an attempt for connection to the image forming apparatus through the control connection according to FTP is permitted, print option control connection and data connection are performed, not necessarily in sequence. As shown in FIG. 4, the transmission unit 130 includes a first port 130a for transmitting extension commands to the image forming apparatus 200, and a second port 130b for transmitting print data to the image forming apparatus. If the FTP extension commands are defined according to the RFC, port 21, which is originally used for transmitting standard FTP commands, may be used as the first port 130a for transmitting the FTP extension commands. In this manner, port resources can be conserved.

Alternatively, if the image forming apparatus does not support an FTP extension command of interest, step S410, the transmission unit 130 executes the control and data connections according to FTP, step S440. Then, a display unit (not shown) may display a message instructing that the extension commands are not supported.

When a connection is achieved through step S420, the control unit 220 of the image forming apparatus 200 parses the command of interest. Then, under the direction of the control unit 220, the print engine 230 executes the printing operation on the received print data by applying the parsed command, step S430.

Alternatively, when a connection is achieved through step S420, the image forming apparatus 200 performs the printing operation according to standard FTP command. In this case, the image forming apparatus acts as a conventional FTP server for the FTP client.

Thus, the printing system and method in accordance with exemplary embodiments of the present invention advantageously employ user terminals and image forming apparatuses for conservation of terminal and image forming apparatus resources, as well as network resources, by using only the FTP protocol.

While the present invention has been particularly shown and described with reference to certain exemplary embodiments thereof, it will be understood by those of ordinary skill in the art that various changes in form and detail may be made therein without departing from the spirit and scope of the present invention as defined by the appended claims and equivalents.

What is claimed is:

1. A printing system using File Transfer Protocol (FTP), comprising:
a user terminal for transmitting print options and print data using FTP; and
an image forming apparatus for receiving the print options and print data, and executing a printing operation by applying the received print options.

2. The printing system of claim 1, wherein the print options are defined in the form of FTP extension commands.

3. The printing system of claim 2, wherein the user terminal transmits the extension commands through a port capable of transmitting standard FTP commands.

4. The printing system of claim 2, wherein, if the image forming apparatus does not support the FTP extension commands, the image forming apparatus ignores the extension commands and executes the printing operation according to standard FTP commands.

5. A printing method using File Transfer Protocol (FTP), the method comprising:
transmitting print options and print data in a user terminal using FTP; and
receiving the print options and print data in an image forming apparatus, and executing a printing operation on the print data by applying the received print options.

6. The method of claim 5, wherein the print options are defined in the form of FTP extension commands.

7. The method of claim 5, wherein the extension commands are transmitted through a port transmitting standard FTP commands.

8. The method of claim 6, further comprising:
if the image forming apparatus does not support the extension commands, the image forming apparatus ignores the extension commands and executes the printing operation according to standard FTP commands.

9. A user terminal using File Transfer Protocol (FTP), comprising:
a user interface unit for receiving print options and print data;
a transmission unit for transmitting the print options and print data provided to an image forming apparatus; and
a control unit for directing the transmission unit to transmit the print options and print data using FTP.

10. The user terminal of claim 9, wherein the print options are defined in the form of FTP extension commands.

11. The user terminal of claim 10, wherein the transmission unit comprises:
a first port for transmitting the extension commands to the image forming apparatus; and
a second port for transmitting the print data to the image forming apparatus.

12. The user terminal of claim 11, wherein the first port is the same port used for transmitting standard FTP commands.

13. An image forming apparatus using File Transfer Protocol (FTP), comprising:
a receiving unit for receiving print options and print data;
a print engine for printing the received print data; and
a control unit for directing the receiving unit to receive the print options and the print data using FTP, and for directing the print engine to execute a printing operation on the print data by applying the received print options.

14. The image forming apparatus of claim 13, wherein the print options are defined in the form of FTP extension commands.

15. The image forming apparatus of claim 14, wherein, if the extension commands are not supported, the control unit ignores the extension commands and performs a control operation according to standard FTP commands.

16. The image forming apparatus of claim 14, wherein the receiving unit comprises:
a first port for receiving the extension commands; and
a second port for receiving the print data.

17. The image forming apparatus of claim 16, wherein the first port is the same port used for receiving standard FTP commands.
